(19) United States
(12) Patent Application Publication
(10) Pub. No.: US 2015/0129567 A1
(43) Pub. Date: May 14, 2015

(54) WELDING SYSTEM WITH SPATTER PROTECTION ASSEMBLY

(71) Applicant: LINCOLN GLOBAL, INC., City of Industry, CA (US)

(72) Inventor: Richard Dean TRAVER, San Diego, CA (US)

(73) Assignee: LINCOLN GLOBAL, INC., City of Industry, CA (US)

(21) Appl. No.: 14/177,259

(22) Filed: Feb. 11, 2014

Related U.S. Application Data
(60) Provisional application No. 61/903,322, filed on Nov. 12, 2013.

(51) Int. Cl. B23K 9/32; B23K 37/02

(52) U.S. Cl. CPC B23K 9/328; B23K 37/0282; B23K 9/321
USPC 219/137 R; 219/136

(57) ABSTRACT

The invention described herein generally pertains to a system and method for protecting welding system components from welding spatter emitted during welding operations.

### PRIORITY CLAIM

This application claims priority to and the benefit of U.S. Provisional Patent Application 61/903,322, filed on Nov. 12, 2013.

### TECHNICAL FIELD

In general, the present invention relates to an assembly adapted to prevent welding spatter from damaging components associated with a welding system. More particularly, the present invention relates to a welding tractor having a sliding spatter shield for preventing welding spatter from infiltrating the tractor body and damaging torch and drive train components contained therein.

### BACKGROUND OF THE INVENTION

Welding systems reside at the core of the modern industrial age. From massive automobile assembly operations to automated manufacturing environments, these systems facilitate joining in ever more complicated manufacturing operations. Hot wire welding processes a wire or electrode being heated (e.g., via current) and received by a puddle created by a main heat source (e.g., plasma arc, tungsten inert gas (TIG) welding, metal inert gas (MIG) welding, flux core, among others). The hot wire welding process includes the resistance heating of the wire up to, or near, a melting point of such wire. A wire heated near or close to the melting point of the wire without arcing events is received by the puddle with little or no disruption, thereby providing a sufficiently strong weld. Even under ideal operating conditions, however, welding processes invariably create “spatter”: metal particles or flux residue expelled during welding operations that do not form a part of the weld. Spatter has deleterious consequences for various welding system components; including, but not limited to, decreased welding efficiency, increased welding component maintenance, and/or welding component failure.

Spatter becomes an even greater threat to welding system operation when torch placement adjustments necessitate moving exterior component parts. For example, welding may involve, raising, cladding, building up, filling, hard facing, overlaying, joining, and other welding applications. When confronted with a workpiece having a curved surface, an orbital welding process may be used to rotate the welding head, or torch, to apply a weld to the curved surface. The most common examples, where orbital welding is used, is the welding of pipe. Pipe welding may include thin wall application where the welding head is rotated about the outer surface of two end pieces being joined together; alternatively, pipe welding may include deep groove geometries where the welding electrode extends into a groove formed between the two pipes being joined to lay down successive beads of weld material to fill the groove and join the thick walled pipes. Welding systems frequently include a torch that is supported by a tractor unit mounted on a guide track, wherein the tractor unit is rotated to supply a weld at desired locations around the circumference of the pipe. Frequently, the tractor unit will contain sensitive welding system components that require protection from spatter. Protecting these interior components from spatter can be difficult where the tractor unit comprises arms, or other support members, that extend away from, and move relative to, the tractor unit in order to permit adjustment of the torch to a desired work piece welding location. These support arms move within tractor unit openings that—unless adequately sealed—leave the interior components vulnerable to spatter infiltration and damage.

Thus, there is a need in the art for a welding system having an assembly adapted to permit free movement of torch support arms while simultaneously protecting welding system components contained within the tractor unit from spatter intrusion.

### SUMMARY OF THE INVENTION

In accordance with an embodiment of the present invention, a welding system may include a welding torch; and a tractor unit, including a housing adapted to support the welding torch and an arm, the housing defining an aperture, wherein at least a portion of the arm extends outward from the housing through the aperture and is movable within the aperture; a flexible spatter shield mounted in the opening and operatively attached to the arm, wherein movement of the arm also causes movement of the spatter shield while maintaining a barrier for preventing welding spatter from entering the tractor unit housing.

In accordance with another embodiment of the present invention A welding system, including a welding torch; and a tractor unit including a plastically deformable spatter shield having an arm hole; an arm, situated at least partially within the spatter shield arm hole, supported by the tractor unit, attached to the torch and adapted to selectively position the torch above a work piece; and a housing adapted to support the arm, wherein the housing includes a first side defining an aperture to receive at least a portion of the arm, and permit movement of the arm therein; wherein movement of the arm also causes movement of the spatter shield while maintaining a barrier for preventing welding spatter from entering the tractor unit housing.

In accordance with another embodiment of the present invention, a method for protecting welding system components from spatter may include the steps of providing a welding torch and a tractor unit comprising a plastically deformable spatter shield, an arm, and a housing; followed by moving the arm, during an adjustment of the torch, in a manner that also causes movement of the spatter shield while maintaining a barrier preventing welding spatter from entering the tractor unit housing.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a partially exploded top front perspective view of portions of a welding system;

FIG. 2 illustrates another partially exploded top front perspective view of portions of a welding system;

FIG. 3 is a cross-sectional side perspective view of an assembled tractor unit of a welding system;

FIG. 4 is a cross-sectional side perspective view of a partially exploded tractor unit of a welding system;

FIGS. 5A-5C illustrate partially assembled top front perspective views of a tractor unit and torch assembly, demonstrating movement and positioning of the spatter shield relative to the position of the support arm, according to an embodiment of the invention for a welding system; and

FIG. 6 illustrates a partially exploded top front perspective view of portions of a welding system according to one embodiment of the present invention.

### DETAILED DESCRIPTION OF THE INVENTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

Embodiments of the invention relate to methods and systems that are designed to protect welding system components from welding spatter, slag, flux or other environmental debris such as dust or dirt. In particular, a welding system is disclosed that utilizes an assembly adapted to prevent intrusion of spatter into the housing of an associated tractor unit containing drive machinery, adjustment machinery or other sensitive electronic or mechanical system components. Specifically, the welding system of the present invention has a plastically deformable spatter shield that prevents spatter, or other debris, from infiltrating the tractor unit housing irrespective of the position of an arm positioning the torch above an associated work piece. In one embodiment, a method for preventing intrusion of welding spatter is disclosed.

“Welding” or “weld” as used herein including any other formatives of these words will refer to depositing of molten material through the operation of an electric arc including but not limited to submerged arc, GTAW, GMAW, MAG, MIG, TIG welding, or any electric arc used with a welding system.

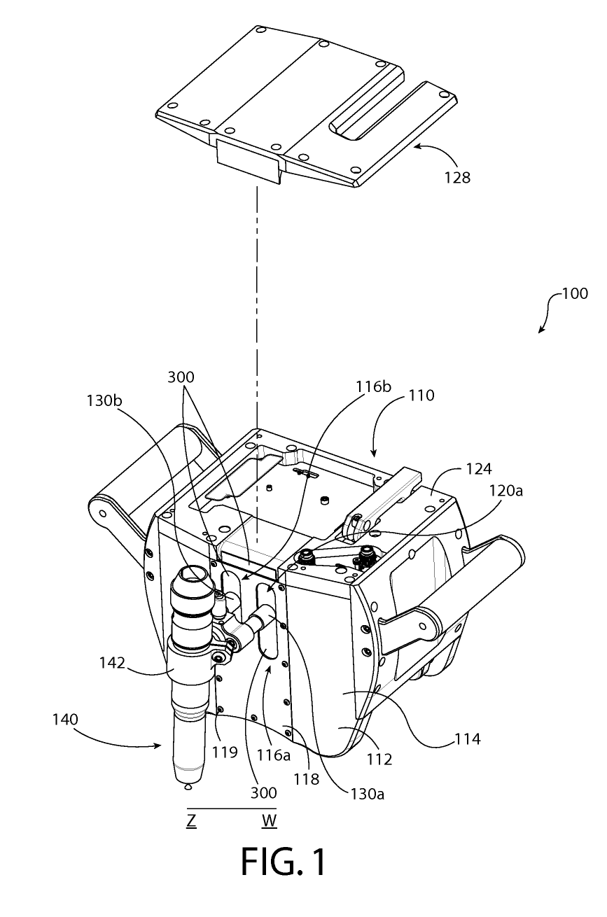

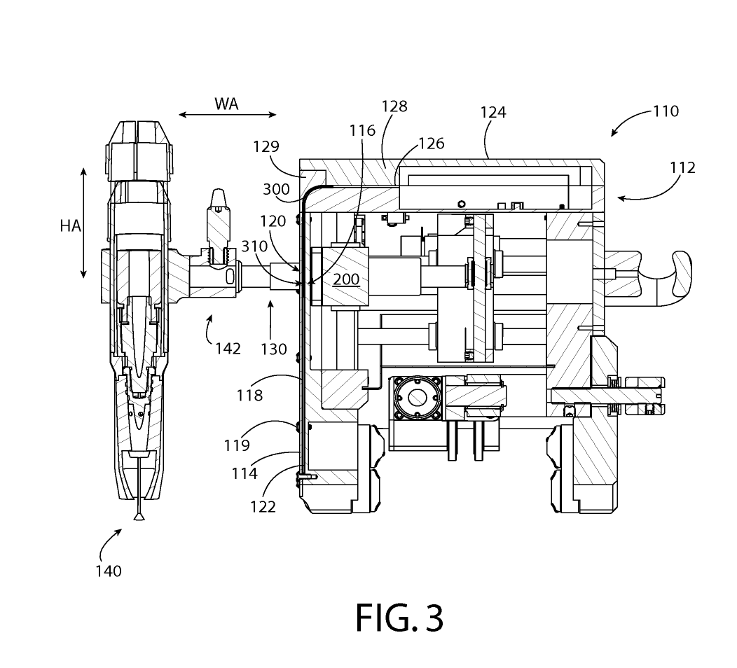

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 1-6 illustrate a tractor unit and associated torch assembly for use in a welding system of the present invention. One illustrative example of a welding system is often used for the joining of tubes or pipes of various types of materials. For example, a Tungsten Inert Gas (TIG) or Gas Tungsten Arc Welding (GTAW) welding torch may be used to orbit around the pipes to be welded together by an automated mechanical system. Specifically, FIGS. 1-6 illustrate an example embodiment of certain components for a welding system 100 (also referred to as welder, system, welding system, and/or welder system) as used in a welding environment. Welding system 100 includes a welding tractor unit 110 that travels around the pipes or tubes, said tractor unit comprising a housing 112 containing other welding system components such as, by way of non-limiting examples, a welding power source (not shown), drive machinery (not shown) for moving the tractor unit about an associated track assembly, and adjustment machinery for positioning an associated torch assembly at the desired location about a work piece. It is to be appreciated that the subject innovation can be used with any orbital or non-orbital welding system. Moreover, the subject innovation can be used with any welding operation that includes an arc and a hot wire that is liquefied to deposit welding material onto a work piece.

In the example shown, welding system 100 includes a welding torch assembly, generally indicated at 140, having a welding electrode for depositing weld material to form a weld joint at the desired welding zone Z, as is well known in the art. Welding torch assembly 140 is connected to a shield gas supply (not shown), that provides an inert gas, such as Argon gas, to welding torch 140. Welding gas supply may include a container, such as a cylinder, that stores shield gas under pressure, and delivery of shield gas, via appropriate tubing or other conduits, may be controlled by a regulator or other controller (not shown). A non-pressurized source may be used also with gas delivery provided by a pump or the like. System 100 may also include a power supply (not shown) that provides a first heat source to create an arc between an electrode (e.g., a non-consumable electrode for instance) and a work piece W, wherein a puddle is created by the electrode. System 100 may further include a hot wire power supply (not shown) (e.g., welding wire power supply) that heats a welding wire fed into a puddle formed by the electrode. In other words, hot wire power supply can energize a welding wire that is fed or delivered into the puddle to deposit welding material (e.g., liquefied welding wire) onto work piece W. Other welding system components, and their operation, are well known in the art, and will not be described in further detail for the sake of brevity; needless to say, any arrangement of such components can be chosen with sound engineering judgment without departing from the intended scope of coverage of the embodiments of the subject invention.

As previously alluded, the example welder shown in associated figures is supported on a track and driven by a tractor unit 110 around pipe (also referred to as work piece W) in any manner chosen with sound engineering judgment that is known in association with welding systems. The tractor unit 110 may comprise, at least, a track guide 150 and a housing 112 that contains various welding systems components. In the embodiment shown in FIG. 1, the housing 112 is a substantially rectangular box arrangement, but it is to be understood that the housing 112 can be of any shape or dimensions as might be necessary to accommodate supported components or engineering requirements without departing from the scope of the invention.

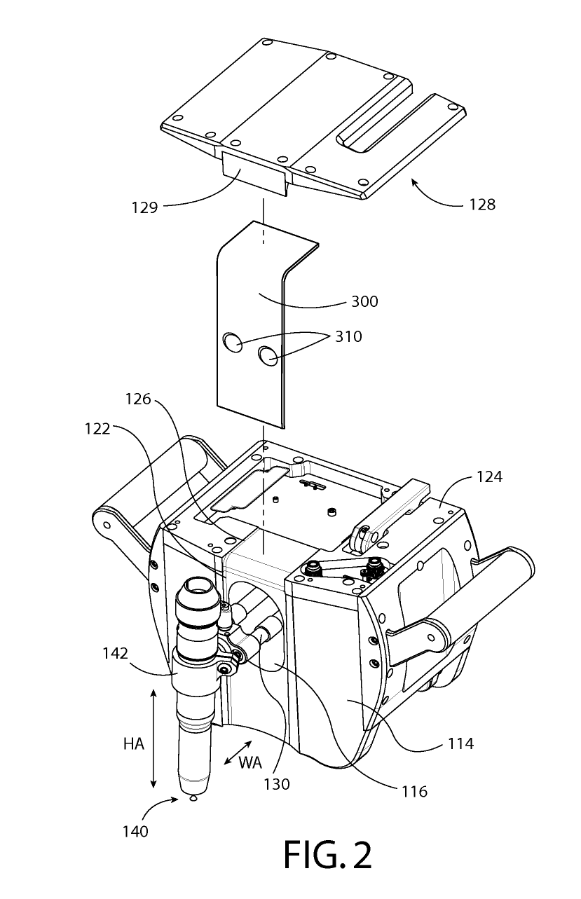

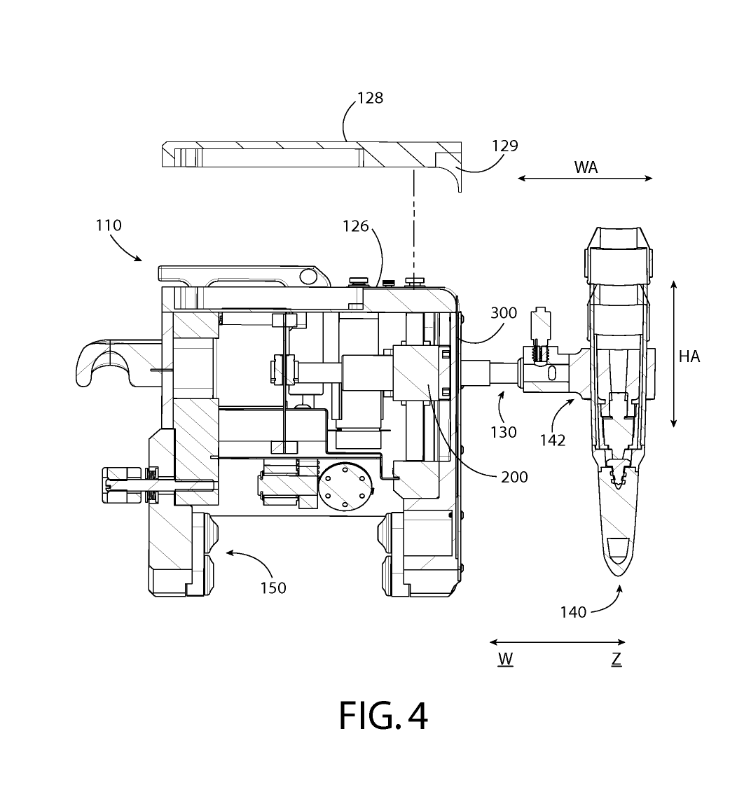

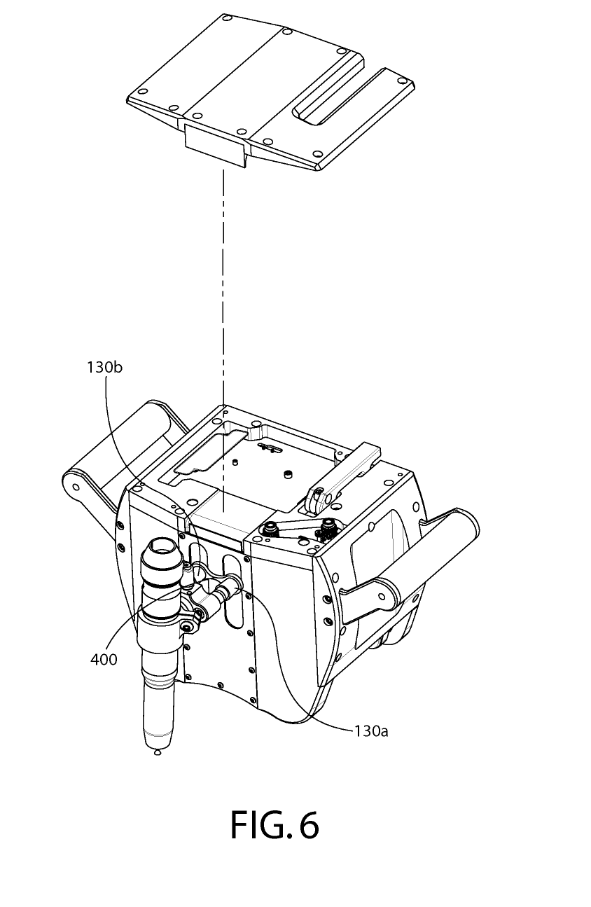

Adjustment of the torch assembly 140 in relation to the tractor unit 110 and an associated work piece W will now be described. In one embodiment, the torch assembly 140 may be supported by a mount system 142 which is coupled to at least one adjustment arm 130 that allows adjustment of mount system 142 (and attached torch assembly 140) toward welding zone Z or away from welding zone Z. It is to be appreciated that the adjustment toward welding zone Z or away from welding zone Z can be automated or semi-automated. As shown in FIGS. 1 and 4, the arm 130, or arms 130a, 130b, may be coupled to adjustment motor 200 contained within, and supported by, the tractor unit 110. As shown in FIGS. 2 and 4, the arm 130 and associated adjustment motor 200 may be adapted to move the mount system 142 in at least two directions: a height adjustment HA and a width adjustment WA; it should be understood that any other directional adjustment may also fall within the scope of the invention. As shown in FIG. 4, a width adjustment WA generally consists of movement of the torch assembly 140 in a direction substantially parallel to an associated work piece W; the width adjustment WA may optionally be effectuated by an arm 130 adapted for telescoping movement (as shown generally in FIG. 6) driven by associated adjustment motor 200. In contrast, as shown in FIG. 4, the height adjustment HA is accomplished by actuation of the adjustment motor 200 so as to cause movement of the arm 130 in a direction substantially vertical from an associated work piece W.

As discussed above, it is to be appreciated and understood that any suitable adjustment motor 200 and/or adjustment arm mechanism 130, as are known in the art, can be implemented with the subject innovation and the systems shown in FIGS. 1-5 are not to be limiting on the scope of the subject claims. As shown in FIG. 1, however, the adjustment arm 130 may extend in a substantially perpendicular direction away from a first side 114 of the housing 112. In one embodiment, the first side of the housing 114 has at least one guide aperture 116 within which the arm 130 at least partially resides and is permitted to move so as to effectuate a height adjustment HA of the torch assembly 140. As shown in FIG. 1, the welding system 100 may comprise a mount assembly 142 supported by a pair of adjustment arms 130a, 130b which are operatively attached to and supported by associated adjustment machinery residing within the tractor unit 110; said adjustment arms 130a, 130b passing through a pair of elongated guide apertures 116a, 116b on the first side 114 of the tractor unit housing 112 that are adapted to guide movement of the arms 130a, 130b during a height adjustment HA. Although the guide apertures shown in FIG. 1 are elongated ovals, it is to be understood that a guide aperture 116 may be of any size or shape selected by a person of skill in the art to permit a height of width adjustment HA, WA of the mount assembly 142 and attached torch 140.

As can be seen with reference to FIGS. 1 and 2, apart from the guide aperture 116, the tractor unit 110 is a substantially closed system designed to support and transport welding system 100 components during welding operations. Without the benefits of the arrangement of the present invention, however, the housing's guide aperture 116—which is necessary for movement of the adjustment arms 130 and associated torch assembly 140—also permits intrusion of welding spatter into the tractor unit 110. The welding system 100 disclosed herein solves the problem of spatter intrusion into adjustment member apertures, thereby alleviating related component deterioration, by providing a spatter shield 300 that provides a barrier between the tractor unit housing 112 and supported adjustment arm 130 irrespective of movement or position of the arm 130. In one embodiment, the spatter shield 300 and arm 130 may have a fluid tight seal.

Specifically, with reference now to FIGS. 1-2, the spatter shield 300 of the present invention may be a heat resistant material and may have at least one arm hole 310 adapted to receive a portion of an associated adjustment arm 130 in a fashion that provides a barrier against spatter intrusion. In an embodiment, the spatter shield 300 may consist of a plastically deformable (flexible) heat resistant material. Materials that are not plastically deformable may be used and joined with hinges or the like to form a flexible spatter shield. For example, non-flexible segments of material may be joined together with a flexible backing or hinge material that allows the spatter shield 300 to move with the arm along the track defined in the housing. According to another example, non-flexible segments may be hinged like a garage door such that when the segments are aligned in a plane, they overlap to prevent penetration of the spatter into the housing, but as they transition along an arc are permitted to hinge relative to each other.

In an embodiment, the spatter shield 300 may consist of a material that has a low coefficient of friction or a self lubricating material enabling ease of movement even where pressed against a housing 112 surface. Alternatively, low-friction coatings or lubricating materials may be used at the interface between the spatter shield 300 and the housing. In an embodiment, the spatter shield 300 may be constructed of a flexible plastic material, such as a polytetrafluoroethylene (PTFE) material, such as, Teflon® brand material. The thickness of the spatter shield 300 may vary depending on the type of material used and the size of the housing and arm. Consequently, the described and depicted example should not be considered limiting. In the example shown, a PTFE spatter shield is used having a thickness of approximately 30/1000 of an inch. The PTFE material should not be considered limiting as other plastics, metals, ceramics or combinations thereof may be used to form a spatter shield according to the invention.

In operation, as can be contemplated with references to FIGS. 1 and 2, when an adjustment arm 130 is assembled through the spatter shield arm hole 310, or otherwise operatively attached to the arm 130, the spatter shield 300 of the present invention is seated along an inner surface of the housing's first side 114 so as to provide a barrier to spatter intrusion through a guide aperture 116 of the tractor unit housing 112. Said barrier is achieved without regard to the position the adjustment arm 130, or arms 130a, 130b, within the associated guide aperture 116, or apertures 116a, 116b. Said barrier is maintained during movement of the adjustment arm 130, or arms 130a, 130b, during a height adjustment HA or width adjustment WA.

In one embodiment, generally shown in FIGS. 1, 2 and 4, the mount system 142 is attached to a pair of adjustment arms 130a, 130b supported by the tractor unit 110, wherein the arms 130a, 130b pass through the arm holes 310a, 310b of the spatter shield 300 before passing through a pair of elongated oval guide apertures 116a, 116b on a first side 114 of an associated tractor unit housing 112. In another embodiment, specifically shown in FIGS. 1 and 4, the tractor unit 110 may additionally comprise a cover plate 118 having cover slots 120a, 120b; said cover plate 118 may be releasably attached to the first side 114 of the housing 112, via fasteners 119; assembly of said cover plate 118 may create a recess track 122 between an outer surface of the first housing side 114 and an inside surface of the cover plate 118 which guides vertical movement of the spatter shield 300 during height adjustment HA. In an embodiment, the pair of adjustment arms 130a, 130b may first pass through a guide aperture 116 (as shown in FIGS. 1 and 2), or a pair of guide apertures 116a, 116b, in the housing's first side 114, followed by passage through arm holes 310 in an associated spatter shield 300, followed by passage through the cover slots 120a, 120b of an associated cover plate 118. In another embodiment, the arms 130a, 130b may be stabilized during torch adjustments with a coupling member 400. It should be noted that although shapes have generally been included when describing aperture guides 116, arm holes 310 and cover slots 120, these aspects of the invention may take any shape selected by a person of ordinary skill in the art that may be necessary, based on sound engineering judgment and the movement arc of adjustment arms 130a, 130b, to accomplish welding system requirements.

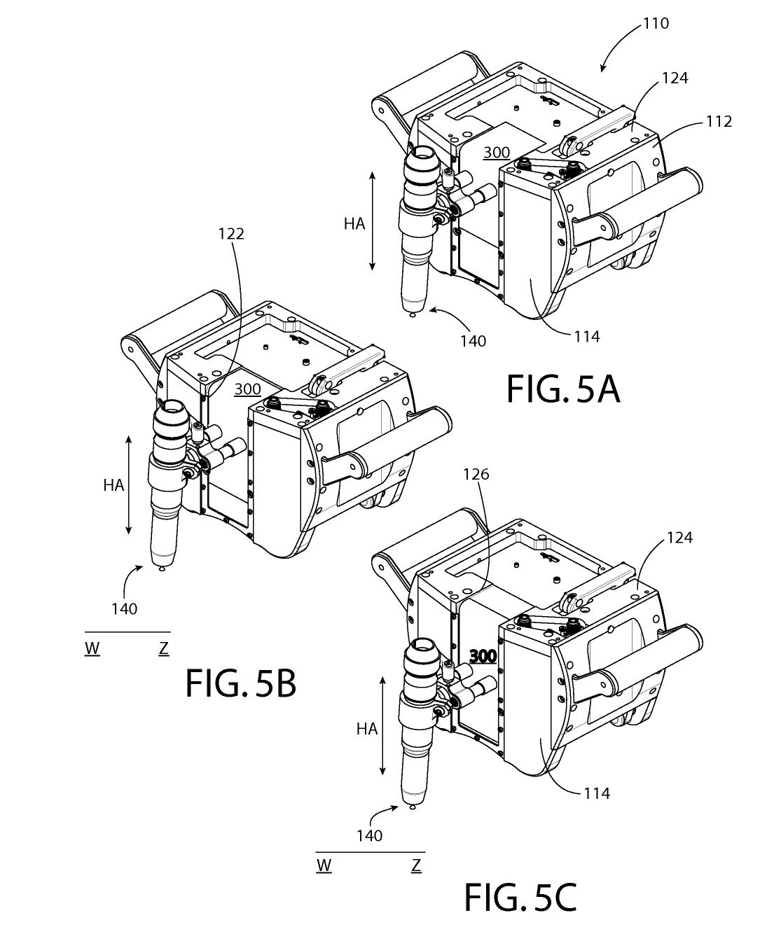

As can be seen with reference to FIGS. 5A through 5C (all shown with the associated cover plate 118 removed), an assembled spatter shield 300 engages, or is operatively attached to, the adjustment arms 130 and acts as a barrier to spatter intrusion through aperture guides 116 (obscured by spatter shield 300) in the housing 112 irrespective of the position of the arms 130a, 130b within the associated height adjustment range HA. Indeed, FIGS. 5A through 5C further illustrate movement of the spatter shield 300 within the tractor unit housing 112 during height adjustments HA, according to one embodiment of the invention. FIG. 5C shows the adjustment arms 130a, 130b in a lowered position relative to a work piece W, wherein substantially all of the spatter shield 300 resides within the recess track 122 located on the housing's first side 114. FIGS. 5A and 5B illustrate how a plastically deformable spatter shield 300 can be deformed so as to remain seated within the housing 112 during a height adjustment HA. In particular, FIGS. 5A and 5B demonstrate how raising the adjustment arms 130a, 130b vertically away from the work piece W during a height adjustment HA moves the spatter shield 300 from a position residing substantially within the first side's recess track 122 to a position at least partially residing on an outside surface of a perpendicular second side 124 of the housing 112. In one embodiment, the second side 124 of the housing 112 may additionally comprise a recess guide 126 formed by assembly of an associated cover cap 128 onto the second housing side 124 (in much the same way the recess track 122 is created by assembly of the cover plate 118 onto the housing first side 114); in this embodiment, when adjustment arm 130 is raised vertically away from the work piece W, the spatter shield 300 is moved further out of the recess track 122 and further into the recess guide 126 of the second side 124. In some embodiments, the cover cap 128 may additionally comprise a diverter 129, which may optionally consist of a curved component adapted to facilitate transition of the spatter shield 300 between the recess track 122 and the recess guide 126. By way of example, movement of the spatter shield 300 from a position substantially parallel to the housing's first side 114 into a position at least partially parallel to a perpendicular second side 124 of the housing, or alternatively from a position within the recess track 122 to a position partially within the recess guide 126, is similar to the movement of a garage door as it raised from a closed position into an open, or partially open, position.

FIGS. 5A-5C are also illustrative of methods for protecting welding system components, particularly components contained within a tractor unit housing 112, from spatter generated during welding operations. Namely, a method for protecting welding system components from spatter may comprise some or all of: A) providing: 1) a welding torch 140; and 2) a tractor unit 110 comprising a plastically deformable spatter shield 300 having an arm hole 310; an arm 130 situated at least partially within the spatter shield arm hole 310, supported by the tractor unit 110 and adapted to selectively position the torch 140 above a work piece W; and a housing 112, adapted to support welding system components, having a first side 114 with an aperture guide 116 adapted to receive a portion of, and permit movement of, the arm 130; wherein B) movement of the arm 130 also causes movement of the spatter shield 300 while maintaining a barrier preventing welding spatter from entering the tractor unit housing 112.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit of scope of the above discussed inventions. The embodiments and discussions herein can be readily incorporated into any of these systems and methodologies by those skilled in the art.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding system, comprising:
a welding torch; and
a tractor unit, comprising:
a housing adapted to support the welding torch and an arm, the housing defining an aperture, wherein at least a portion of the arm extends outward from the housing through the aperture and is movable within the aperture;
a flexible spatter shield mounted in the opening and operatively attached to the arm, wherein movement of the arm also causes movement of the spatter shield while maintaining a barrier for preventing welding spatter from entering the tractor unit housing.

2. The welding system of claim 1, wherein the spatter shield comprises a material with heat resistant properties.

3. The welding system of claim 1, wherein the spatter shield is made of polytetrafluoroethylene.

4. The welding system of claim 1, wherein the spatter shield is made of Teflon® brand material.

5. The welding system of claim 1, wherein the spatter shield is approximately 30/1000 of an inch in thickness.

6. A welding system, comprising:
a welding torch; and
a tractor unit, comprising:
a plastically deformable spatter shield having an arm hole;
an arm, situated at least partially within the spatter shield arm hole, supported by the tractor unit, attached to the torch and adapted to selectively position the torch above a work piece; and
a housing adapted to support the arm, wherein the housing comprises:
a first side defining an aperture to receive at least a portion of the arm, and permit movement of the arm therein;
wherein movement of the arm also causes movement of the spatter shield while maintaining a barrier for preventing welding spatter from entering the tractor unit housing.

7. The welding system of claim 6, wherein the housing additionally comprises a cover plate, adapted to be releasably attached to the housing's first side in a manner that creates a recess track for guiding the spatter shield within the housing during movement of the arm, and having a cover slot for receiving at least a portion of an associated arm.

8. The welding system of claim 6, wherein the housing additionally comprises a second side perpendicular to the housing's first side, and wherein the spatter shield moves from a position substantially parallel to the first side to a position substantially parallel to the second side during a torch height adjustment.

9. The welding system of claim 8, wherein the housing additionally comprises a cover cap adapted to transition a portion of the spatter shield from a position parallel to the first side to a position parallel to the second side during movement of the arm.

10. The welding system of claim 9, wherein the cover cap comprises a diverter having a curved interior surface located between the first side and the second side and engaging the spatter shield.

11. The welding system of claim 6, wherein the welding torch is supported on the arm by a mount system.

12. The welding system of claim of claim 11, wherein the arm includes a pair of adjustment arms, the spatter shield has a pair of arm holes, the housing's first side has a pair of aperture guides and the mount system is supported on the pair of adjustment arms externally of the spatter shield.

13. The welding system of claim 12, wherein the pair of arms are stabilized by a coupling member.

14. The welding system of claim 12, wherein the arms are supported by an associated adjustment motor adapted to mechanically effectuate a torch height adjustment.

15. The welding system of claim 6, wherein the arm includes a telescoping component adapted to selectively move inward and outward relative to the housing.

16. A method for protecting welding system components from spatter, comprising:
A) providing a welding system comprising:
1) a welding torch; and
2) a tractor unit, comprising:
a plastically deformable spatter shield;
an arm; and
a housing, adapted to support welding system components;
B) moving the arm, during an adjustment of the torch, in a manner that also causes movement of the spatter shield while maintaining a barrier preventing welding spatter from entering the tractor unit housing.

17. The method of claim 16, wherein:
the plastically deformable spatter shield has at least one arm hole;
the arm is situated at least partially within the spatter shield arm hole, is supported by the tractor unit and is adapted to selectively position the torch above a work piece; and
the housing comprises a first side with an aperture guide adapted to receive a portion of, and permit movement of, the arm.

18. The method of claim 19, wherein the welding system components contained within the tractor unit are protected from welding spatter intrusion during a torch height adjustment and a torch width adjustment.
